(19) United States
(12) Patent Application Publication
(10) Pub. No.: US 2010/0312591 A1
(43) Pub. Date: Dec. 9, 2010

(54) Automatic Vehicle Dispatch System and Method

(75) Inventor: Jason Wu, Taipei City (TW)

Correspondence Address: SCHMEISER OLSEN & WATTS, 18 E UNIVERSITY DRIVE, SUITE # 101, MESA, AZ, 85201, US

(73) Assignee: Shih Pi Ta Technology Ltd., Taipei City (TW)

(21) Appl. No.: 12/477,630

(22) Filed: Jun. 3, 2009

(51) Int. Cl. G06Q 10/00; G10L 21/00

(52) U.S. Cl. 705/7; 704/270

(57) ABSTRACT

An automatic chauffeured vehicle dispatch system and method are disclosed. In the vehicle dispatch system, audio signals and an automated management system are used. The automatic chauffeured vehicle dispatch system of the present invention comprises a service system, a dispatch system, a dispatch center server, an address analysis module, a databank server and a voice conversion module. The dispatch center server is connected with a telecommunication network, the internet, a databank server, a voice conversion module, the service system and the dispatch system. The address analysis module is able to analyze patrons' addresses and store the addresses in the databank server in the order of frequency of use. The voice conversion module is connected with the databank server and is able to covert the addresses stored in the databank server into audio signals, which may be sent to clients via the dispatch center server and a communication network.

### BACKGROUND OF THE INVENTION

1. Field of the Invention

The invention generally relates to an automatic chauffeured vehicle dispatch system and method. More particularly, the invention relates to an automatic chauffeured vehicle dispatch system in which audio signals and an automated management system are used to achieve the goals of safety, high reliability, lower labor cost and efficiency.

2. Description of the Prior Art

In the chauffeured vehicle dispatch system of the prior art, customers may use a telephone or the internet to call the dispatch call center for a vehicle. After the dispatch center receives a call for a vehicle, a dispatcher may use a radio device to ask all the drivers which driver may arrive at the location within the time specified by the client and then select a driver among them. Currently, to enhance the safety of clients, all vehicles in a fleet may be equipped with a GPS system and a mobile communication network (such as GSM or other wireless) which are used to transmit the exact location of each vehicle to the dispatch center. Also, the dispatch operation related data are stored in the dispatch center server. The dispatch center may communicate with the drivers via this mobile communication network. Therefore, a dispatcher at the dispatch center may know the exact location of each vehicle at any moment; the dispatcher may tell only the drivers nearest the location specified by a client about the request and then select a driver to pick up the fare.

Therefore, in prior art vehicle dispatch systems a lot of labor is needed to run the system and a salary must be paid to each of the dispatchers. In fact, the main cost of running a dispatch service is labor costs. In addition, dispatchers may not be able to carry out dispatching effectively and it may take a long time for them to communicate with the drivers as well as with the customer concerning a single dispatch. Moreover, because experience usually plays an important role in vehicle dispatch, training must be provided to a new dispatcher if an experienced dispatcher quits. Furthermore, when ordering a vehicle, a customer needs to wait in the calling queue for an unpredictable length of time before communicating with the dispatcher about the fare. This process can be very annoying and time consuming for customers.

From the above, we can see that the prior art vehicle dispatch systems have many disadvantages and needs to be improved.

To eliminate the disadvantages of the prior art vehicle dispatch systems, the inventor, who has a wealth of experience in the sale, research and development of many types of electronic and communication devices, has put in a lot of effort in the subject and has successfully come up with the automatic chauffeured vehicle dispatch system of the present invention.

### SUMMARY OF THE INVENTION

The main object of the present invention is to provide a automatic chauffeured vehicle dispatch system and method that use a databank to store frequently used addresses of each client and use a voice conversion module to convert addresses into audio signals so as to reduce human errors and save time.

Another object of the present invention is to provide an automatic chauffeured vehicle dispatch system and method in which phone numbers are used for the fast identification of each client and the frequently used addresses of each client are stored so that the dispatch center server may operate more effectively.

To reach these objects, the automatic chauffeured vehicle dispatch system and such method of the present invention are disclosed. The automatic chauffeured vehicle dispatch system of the present invention comprises a service system, a dispatch system, a dispatch center server, an address analysis module, a databank server and a voice conversion module. The service system is able to connect each client with a service person, who may input new data to a databank server. The dispatch system is able to receive data sent from the dispatch center server and dispatch vehicles to locations or addresses specified by clients. The dispatch center server is connected with a telecommunication network, the internet, the databank server, the voice conversion module, the service system and the dispatch system. The address analysis module is able to analyze frequently used addresses of each client and store the addresses in the databank server in the order of the frequency of use. The databank server is able to store clients' data and the clients' addresses after they are analyzed and processed by the address analysis module. The voice conversion module is connected with the databank server and is able to covert the addresses stored in the databank server into audio signals, which may be sent to clients via the dispatch center server and a communication network.

### DETAILED DESCRIPTION OF THE PREFERRED EMBODIMENT

Please see FIG. 1, which illustrates the framework of the automatic chauffeured vehicle dispatch system and method of the present invention. The framework comprises a service system 4, a dispatch system 6, a dispatch center server 3, an address analysis module 9, a databank server 7 and a voice conversion module 8. The service system 4 may connect a client 1 or a VOIP client 11 with a service person 5, who may input new data into the databank server 7. The dispatch system 6 may receive data sent from the dispatch center server 3 and dispatch vehicles to addresses specified by clients. The dispatch center server 3 is connected with a telecommunication network 2, the internet 10, the databank server 7, a voice conversion module 8, the service system 4 and the dispatch system 6. The address analysis module 9 may analyze clients' addresses and store the addresses in the databank server 7 in the order of frequency of use. The databank server 7 may store clients' data and addresses after they are analyzed and processed by the address analysis module 9. The voice conversion module 8 is connected with the databank server 7 and may covert the clients' addresses stored in the databank server 7 into audio signals, which may be sent to clients via the dispatch center server 3, telecommunication network 2 and internet 10.

Now, referring to FIGS. 1 and 2, which illustrate the framework and flowchart of the automatic chauffeured vehicle dispatch system and method of the present invention. When a client makes a call 20, the call is put through to the dispatch center server 3 (21) via a communication network 13 (such as the telecommunication network 2 or the internet 10). Because of the wide use of Skype and MSN, many VOIP clients 11 may utilize such VOIP (voice over internet protocol) technology to call up the dispatch center server 3. The dispatch center server 3 would check whether the client's ID and frequently used addresses exist in the databank server 7 by using his phone number or other telecommunication data as identification ID (22). If not, the call would be forwarded to a service person 5 of the service system 4 (23), and new data of a client may be input into the databank server 7 via the internet 10 or manually input into the databank server 7 by a service person 5. If an identification ID is not available when the call is received, a client may input his phone number or use the dial tones to input his phone number or code number as identification ID, and then the dispatch center server 3 may utilize such ID to locate the client's data stored in the databank server 7. After the client's data stored in the databank server 7 are located and confirmed, the dispatch center server 3 may find a list of the client's addresses stored in the databank server 7 (24) and then the voice conversion module 8 may convert them into audio signals (25), which may then be transmitted to the dispatch center server 3 and then to the client's communication device 26 via the communication network 13 (such as the telecommunication network 2 or the internet 10). Alternatively, such list of addresses may be sent to the client's communication device (26) in the format of text via the telecommunication network 2 or the internet 10 without conversion to audio format. In the case of two or more addresses in the list, the client may use the buttons or keyboard of his communication device (26) to select the appropriate address from the list of addresses under both audio and text formats. If the client's address is not among the list of addresses, the dispatch center server 3 would transfer the call to a service person 5 of the service system 4. After the client selects one of the addresses in the list, such selection would be forwarded to the dispatch center server 3 via the communication network 13 (such as the telecommunication network 2 or the internet 10). Then, the address selected by the client and the client's detail data in the format of audio signal or text would be forwarded to the dispatch system 6, which would then dispatch a vehicle to the address selected by the client (29).

The address analysis module 9 may analyze each client's addresses and store the addresses in the databank server 7 in the order of frequency of use. The address analysis module 9 may be set to update the order of each client's addresses periodically at a preset interval or instantaneously when a call to hire a vehicle is done; in addition, the address analysis module 9 may update the clients' address lists stored in the databank server 7 periodically or instantaneously.

The voice conversion module 8 may convert a client's address list stored in the databank server 7 into audio signals instantaneously at the time when the client makes a phone call to allow him to listen to these audio signals. Alternatively, the voice conversion module 8 may convert a client's list of addresses into audio signals prior to the client calling in to hire a vehicle and store these audio signals in the databank server 7 in the form of an audio file beforehand and allow him to listen to these audio signals next time when he calls in to hire a vehicle. Regarding FIGS. 1 and 3, when a client makes a phone call 30, the call will be connected to the dispatch center server 3 (31) via the communication network 13 (such as the telecommunication network 2 or the internet 10). Some VOIP clients 11 may utilize Skype or MSN (via the internet 10 and the VOIP technology) to call up the dispatch center server 3. The dispatch center server 3 would check whether the client's ID and frequently used addresses exist in the databank server 7 by using his phone number or other telecommunication data (32) as identification ID. If this information does not exist, the call would be forwarded to a service person 5 of the service system 4 (33). If an identification ID is not available when the call is received, a client may input his phone number or use the dial tones to input his phone number or code number as identification ID, and then the dispatch center server 3 may utilize such ID to locate the client's data stored in the databank server 7. After the client's data stored in the databank server 7 are located and confirmed, the databank server 7 may retrieve a list of the client's addresses and their pre-converted audio signals stored in the databank server 7 (34). The list of audio signals may then be transmitted to the client's communication device (35) via the communication network 13 (such as the telecommunication network 2 or the internet 10). Then the client may use the keyboard of his communication device to select one of the addresses in the list of addresses sent from dispatch center server (36). If the client's address is not among the list of addresses, the dispatch center server 3 would transfer the call to a service person 5 of the service system 4 (37). If the client selects one of the addresses in the list, such selection would be forwarded to the dispatch center server 3 via the communication network 13 (such as the telecommunication network 2 or the internet 10). Then, the address selected by the client and the client's other related data in the format of audio signal or text would be forwarded to the dispatch system 6, which would then dispatch a vehicle to the address selected by the client (38).

Although a preferred embodiment of the present invention has been described in detail hereinabove, it should be understood that the preferred embodiment is to be regarded in an illustrative manner rather than a restrictive manner, and all variations and modifications of the basic inventive concepts herein taught still fall within the scope of the present invention.

From the above, we can see that the automatic chauffeured vehicle dispatch system and such method of the present invention meet the relevant patent requirements. It is hoped that the patent application will be approved.

### BRIEF DESCRIPTION OF THE DRAWINGS

FIG. 1 is a block diagram schematically illustrating the framework of the automatic chauffeured vehicle dispatch system and method of the present invention.

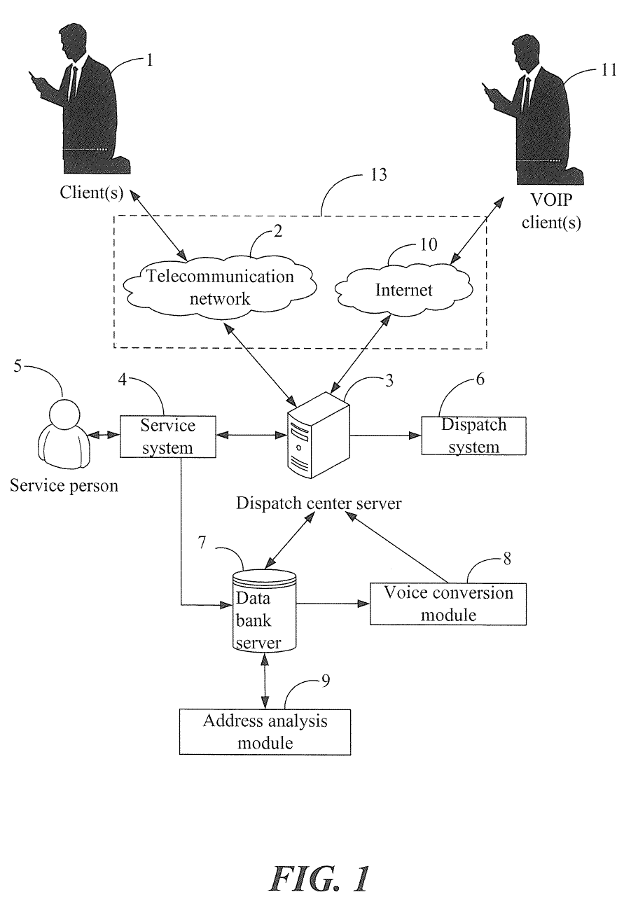

FIG. 2 is a flowchart schematically illustrating the automatic chauffeured vehicle dispatch system and method of the present invention.

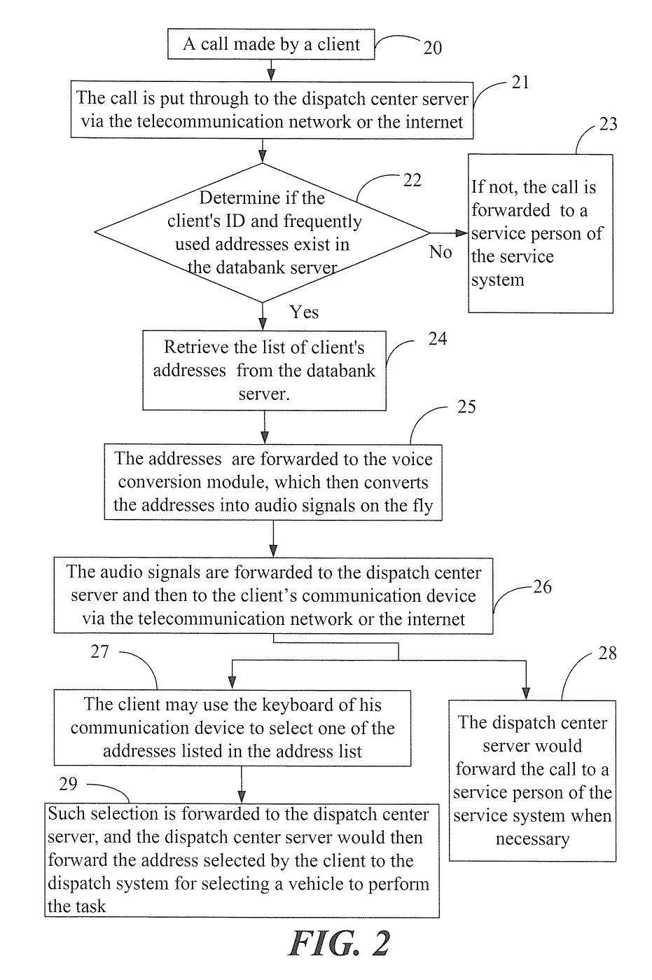

FIG. 3 is a flowchart schematically illustrating the automatic chauffeured vehicle dispatch system and method incorporating the periodical voice conversion of the present invention.

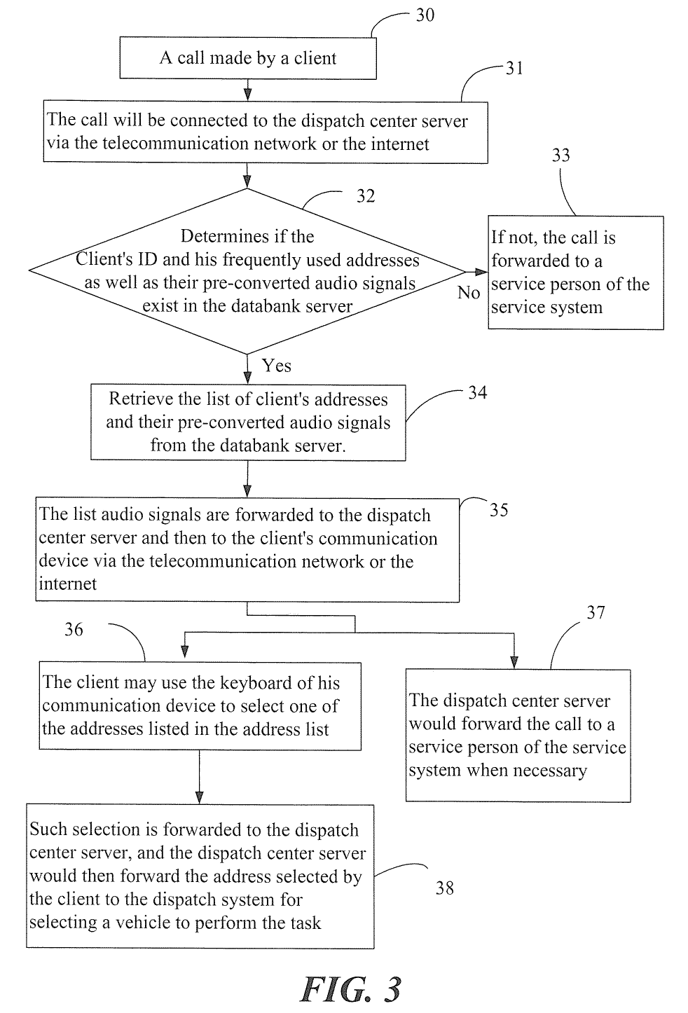

What is claimed is:

1. An automatic chauffeured vehicle dispatch system, comprising:
a service system, able to connect each client with a service person, who may input new data into a databank server;
a dispatch system, able to receive data sent from a dispatch center server and dispatch vehicles to locations or addresses specified by clients;
a dispatch center server, connected with a telecommunication network, the internet, a databank server, a voice conversion module, the service system and the dispatch system;
an address analysis module, able to analyze patrons' frequently used addresses and stores the addresses in a databank server in the order of frequency of use;
a databank server, able to store clients' data and the frequently used addresses after they are analyzed and processed by the address analysis module; and
a voice conversion module, connected with the databank server and able to covert the addresses stored in the databank server into audio signals, which may be sent to clients' end via the dispatch center server and a communication network.

2. The automatic chauffeured vehicle dispatch system as in claim 1, wherein the communication network is a telecommunication network, which is connected with the dispatch center server.

3. The automatic chauffeured vehicle dispatch system as in claim 1, wherein the communication network is the internet, which is connected with the dispatch center server, so that clients may utilize the VOIP technology and the internet to call up the dispatch center server.

4. The automatic chauffeured vehicle dispatch system as in claim 1, wherein the address analysis module may be set to update the order of each client's list of addresses periodically and then update the list of clients' addresses in the databank server accordingly.

5. The automatic chauffeured vehicle dispatch system as in claim 1, wherein the address analysis module may be set to update the order of each client's list of addresses instantaneously each time when a call to hire a vehicle is done and then update the client's address lists in the databank server accordingly.

6. The automatic chauffeured vehicle dispatch system as in claim 1, wherein the order of a client's list of address may be set by the corresponding client by using a network or by making a phone call to a service person, who may then set the order.

7. The automatic chauffeured vehicle dispatch system as in claim 1, wherein the voice conversion module may convert a client's list of addresses contained in the databank server into audio signals and store these audio signals in the databank server in the form of audio file beforehand and allow the client to listen to these pre-converted audio signals at the time when he makes a phone call.

8. The automatic chauffeured vehicle dispatch system as in claim 1, wherein the voice conversion module may convert a client's list of addresses contained in the databank server into audio signals instantaneously when he calls in to hire a vehicle and then store these audio signals in the databank server in the form of audio file to allow him to listen to these audio signals.

9. An automatic chauffeured vehicle dispatch method, comprising the following 8 steps:
(1) When a client makes a phone call, the call is put through to the dispatch center server via a communication network;
(2) The dispatch center server would check whether the client's ID and data exist in the databank server by using his phone number or other telecommunication data as identification ID;
(3) If the client's ID and data exist in the databank server, the dispatch center server would retrieve the list of the frequently used addresses of the client;
(4) The voice conversion module converts a client's list of addresses contained in the databank server into audio signals;
(5) The audio signals are sent to the dispatch center server and then to the client's communication device via the communication network;
(6) The client may use the buttons or keyboard of his communication device to select an appropriate address in the list of addresses converted by the voice conversion module. If the client's choice of address is not among the list of addresses, the dispatch center server would forward the call to a service person of the service system;
(7) After the client uses the buttons or keyboard of his communication device to select an appropriate address in the list of addresses converted by the voice conversion module, the selected address is sent to the dispatch center server via the communication network; and
(8) The dispatch center server forwards the address selected by the client and the client's other related data to the dispatch system, which would then dispatch a vehicle to the address selected by the client;

10. The automatic chauffeured vehicle dispatch method as in claim 9, wherein the communication network is a telecommunication network.

11. The automatic chauffeured vehicle dispatch method as in claim 9, wherein the communication network is the internet

12. The automatic chauffeured vehicle dispatch method as in claim 11, wherein clients may utilize the VOIP technology and the internet to call up the dispatch center server;

13. The automatic chauffeured vehicle dispatch method as in claim 9, wherein in step (2) the first set of the client's data mentioned is input into the databank server via the internet;

14. The automatic chauffeured vehicle dispatch method as in claim 9, wherein in step (2) the first set of the client's data mentioned is manually input into the databank server by a service person of the service system.

15. The automatic chauffeured vehicle dispatch method as in claim 9, wherein the voice conversion module may convert a client's list of addresses contained in the databank server into audio signals instantaneously when the client calls in to order a vehicle and store these audio signals in the databank server in the form of audio file for the client to listen to.

16. The automatic chauffeured vehicle dispatch method as in claim 9, wherein the dispatch center server mentioned in step (5) may send the audio version of the list of addresses to the client's device via a communication network.

17. The automatic chauffeured vehicle dispatch method as in claim 9, wherein the dispatch center server mentioned in step (5) may send the text version of the list of addresses to the client's device via a communication network.

18. The automatic chauffeured vehicle dispatch method as in claim 9, wherein in step (8) the dispatch center server forwards the text version of the address selected by each client and his other related data to the dispatch system and then to the communication device of a vehicle driver.

19. The automatic chauffeured vehicle dispatch method as in claim 9, wherein in step (8) the dispatch center server forwards the audio version, in the form of live broadcast or audio file, of the address selected by each client and his other related data to the dispatch system and then to the communication device of a vehicle driver.

20. An automatic chauffeured vehicle dispatch method, comprising the following steps:
(1) When a client makes a phone call, the call or request is put through to the dispatch center server via a communication network;
(2) The dispatch center server would check whether the client's ID and data exist in the databank server by using his phone number or other telecommunication data as identification ID;
(3) If the client's ID and data exist in the databank server, the dispatch center server would retrieve the list of frequently used addresses of the client and their pre-converted audio signals, which may have been converted by the voice conversion module either periodically at a preset interval or instantaneously when a previous call to hire a vehicle was done;
(4) The dispatch center server sends the list of audio signals to the client's device via a communication network;
(5) The client may use the buttons or keyboard of his communication device to select an appropriate address in the list of audio signals produced previously by the voice conversion module. If the client's choice of address is not among the list of addresses, the dispatch center server would forward the call to a service person of the service system;
(6) After the client uses the buttons or keyboard of his communication device to select an appropriate address in the list of addresses, the selected address is sent to the dispatch center server via the communication network; and
(7) The dispatch center server forwards the address selected by the client and the client's other related data to the dispatch system, which would then dispatch a vehicle to the address selected by the client.

21. The automatic chauffeured vehicle dispatch method as in claim 20, wherein the communication network is a telecommunication network.

22. The automatic chauffeured vehicle dispatch method as in claim 20, wherein the communication network is the internet.

23. The automatic chauffeured vehicle dispatch method as in claim 22, wherein clients may utilize the VOIP technology and the internet to call up the dispatch center server.

24. The automatic chauffeured vehicle dispatch method as in claim 20, wherein the first set of the client's data mentioned in step (2) is input into the databank server via the internet.

25. The automatic chauffeured vehicle dispatch method as in claim 20, wherein the first set of the client's data mentioned in step (2) is manually input into the databank server by a service person of the service system.

26. The automatic chauffeured vehicle dispatch method as in claim 20, where in step (3) the voice conversion module may convert a client's address list contained in the databank server into audio signals and store these audio signals in the databank server in the form of audio file beforehand and allow the client to listen to these pre-converted audio signals at the time when he makes a phone call.

27. The automatic chauffeured vehicle dispatch method as in claim 20, wherein the dispatch center server mentioned in step (4) may send the audio version of the address lists to the clients via a communication network.

28. The automatic chauffeured vehicle dispatch method as in claim 20, wherein the dispatch center server mentioned in step (4) may send the text version of the address lists to the clients via a communication network.

29. The automatic chauffeured vehicle dispatch method as in claim 20, wherein in step (7) the dispatch center server forwards the text version of the address selected by a client and his other related data to the dispatch system and then to the communication device of a vehicle driver.

30. The automatic chauffeured vehicle dispatch method as in claim 20, wherein in step (7) the dispatch center server forwards the audio version, in the form of live broadcast or audio file, of the address selected by a client and his other related data to the dispatch system and then to the communication device of a vehicle driver.
